(19) United States
(12) Patent Application Publication
(10) Pub. No.: US 2006/0218152 A1
(43) Pub. Date: Sep. 28, 2006

(54) Method and system of accessing personal records of individuals over remote communications links

(75) Inventors: Michael Coveley, Richmond Hill (CA); Srdjan Milutinovic, Brampton (CA)

Correspondence Address: VENABLE LLP, P.O. BOX 34385, WASHINGTON, DC, 20045-9998, US

(73) Assignee: Solbyung Coveley, Richmond Hill (CA)

(21) Appl. No.: 11/254,589

(22) Filed: Sep. 23, 2005

Related U.S. Application Data
(60) Provisional application No. 60/612,637, filed on Sep. 24, 2004.

(51) Int. Cl. G06F 17/30

(52) U.S. Cl. 707/10

(57) ABSTRACT

A communications system comprises a record management system storing personal records relating to individuals registered with the record management system and a wireless device carried by at least one of the registered individuals. The wireless device provides an identifier signifying that the individual is registered with the record management system.

### CROSS-RELATED APPLICATIONS

This application claims the benefit of U.S. Provisional Application No. 60/612,637 filed on Sep. 24, 2004 for an invention entitled “Method and System of Accessing Personal records of Individuals Over Remote Communications Links”.

### FIELD OF THE INVENTION

The present invention relates generally to record management and in particular, to a method and system of accessing personal records of individuals over remote communications links.

### BACKGROUND OF THE INVENTION

There exist a number of methods and systems for tracking medical information relating to individuals. In some instances tracked medical information for an individual is stored in different records at a variety of locations such as at a local doctor's office, at one or more specialty clinics and/or at one or more hospitals. Storing medical records in this distributed fashion can be problematic in that the medical information stored in each of the records may vary as a result of updates being made to a medical record at one location that are not conveyed to other locations. In other instances, the medical records for individuals are stored in a common database that can be accessed using computer systems at different locations. When an individual's medical record is updated at one location, the updates are made available when the individual's medical record is retrieved from the database at other locations.

Regardless of the manner by which an individual's medical records are stored, in emergency situations it is often difficult and sometimes impossible to obtain medical information concerning the individual in distress. To that end, individuals suffering severe allergy conditions often wear bracelets to provide visual notice of the wearers' allergy conditions. The bracelets typically carry information identifying the nature of the allergy conditions suffered by the wearers. Although wearing a visual identifier is common practice to allergy sufferers, it is not common practice to individuals suffering other ailments. In situations where such an individual is in distress, medical personnel are often left in the dark concerning the individual's medical condition unless the individual happens to be carrying medication relating to the individual's medical condition.

Although bracelets and other similar identifiers are helpful, they generally only provide limited medical information concerning the individual. Also, the information carried by these identifiers sometimes becomes in public view, if the bracelet flips. Sensitive medical information can therefore get into hands of inappropriate individuals. In view of the above, it will be of no surprise that obtaining a complete medical record of an individual in distress, especially in time sensitive emergency situations, is often impossible. This is particularly the case when the individual in distress is carrying little or no personal identification information. As will be appreciated, improvements to the manner by which personal information concerning individuals is managed are desired.

It is therefore an object of the present invention to provide a novel method and system of accessing personal records of individuals over remote communications links.

### SUMMARY OF THE INVENTION

Accordingly, in one aspect there is provided a communications system comprising:

a record management system storing personal records relating to individuals registered with said record management system; and

a wireless device carried by at least one of said registered individuals, said wireless device providing an identifier signifying that the individual is registered with said record management system.

In one embodiment, a plurality of registered individuals carry a wireless device displaying the identifier. The record management system and each wireless device communicate over a wireless communications link to enable data exchange therebetween. When a communications link is established between a wireless device and the record management system, the personal record relating to the individual carrying the wireless device is accessible via the wireless device. Information in an accessed personal record can be changed using the wireless device. Changes to information in the personal record are transmitted to the record management system and recorded thereby to update the accessed personal record stored by the record management system.

In one embodiment, the identifier is a logo displayed by the wireless device at least upon initialization of the wireless device. The logo may however, also be displayed during operation of the wireless device at periodic intervals.

Each personal record stores at least medical information concerning the individual. Each personal record is access protected to inhibit unauthorized individuals from accessing the personal records.

According to another aspect there is provided a method of accessing a personal record of an individual over a remote communications link comprising:

providing an identifier on a wireless device carried by said individual signifying registration of said individual with a record management system;

establishing a communications link with said record management system;

submitting access data to said record management system signifying authorization to access the personal record of the individual; and

accessing said personal record upon acceptance of said access data.

The method and system of managing personal records of individuals provides advantages in that each individual's personal record can be kept up-to-date through updates made by medical or other authorized personnel over remote communications links. By providing a visual identifier that is carried by each individual and identifies the existence of the individual's personal record in the record management system, medical and/or other authorized personnel can quickly and efficiently obtain and update information concerning an individual that is stored in their personal record. This of course is particularly important in distress situations.

### BRIEF DESCRIPTION OF THE DRAWINGS

An embodiment will now be described more fully with reference to the accompanying drawings in which:

FIG. 1 is a schematic diagram showing a communications system including a record management system accessible over wireless and wired communications links; and

FIG. 2 is a flowchart showing process flow during record access and updating.

### DETAILED DESCRIPTION OF THE EMBODIMENTS

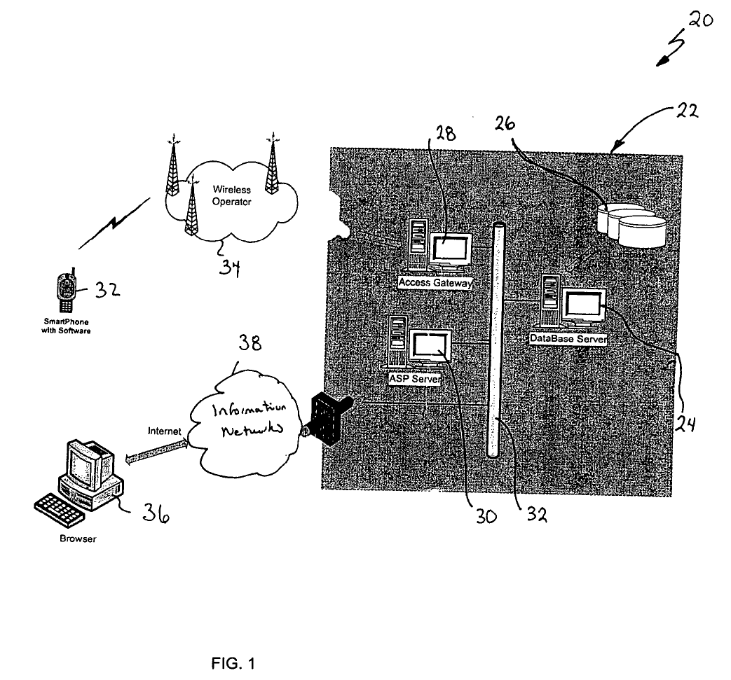

Referring now to FIG. 1, a communications system is shown and is generally identified by reference numeral 20. As can be seen, the communications system 20 includes a record management system 22 accessible over wireless and wired communications links. Record management system 22 comprises a database server 24 that communicates with a database 26 holding personal records of individuals registered with the record management system. Database server 24 also communicates with an access gateway server 28 and an ASP server 30 over an Ethernet based network 32.

The access gateway 28 permits communications to be carried out between the database server 24 and “Smart” wireless devices 32 such as for example, smart cellular telephones and smart-personal digital assistants (PDAs) over a wireless communications network 34. During wireless communications, dynamic private key encryption together with security mechanisms run by the wireless devices 32 and access gateway 28 ensure secure wireless communications. The ASP server 30 permits communications to be carried out between the database server 24 and computing devices 36 such as for example, personal computers (PCs) over one or more information networks 38. During communications of this nature, standard Internet methods such as for example http, asp, xml etc. are used. Standard Internet security mechanisms are also employed to ensure secure communications.

As mentioned above, the database 26 of the record management system 22 stores a personal record for each individual who is registered in the record management system. The personal record for each individual may include one or more files and holds personal information concerning the individual as well as access and security information. The personal information primarily includes medical information although it may also include other information, such as for example psychology information, travel information, food diet information etc., that may in someway be related to an individual's health. The access and security information includes identification, authentication, authorization and security mechanisms to control access to the individual's personal record so that only the individual and authorized medical and/or other personnel are able to access the individual's personal record.

At the time of registration, a personal record is created for the individual. Once the personal record is created, medical history and other related information concerning the individual is entered into the database 26. Access parameters for the individual are then established such as for example authentication number, personal identification number (PIN), password etc.

Medical and/or other authorized personnel are also provided with access parameters to enable medical and other authorized personnel to access specified records stored in the database 26 either on an individual, group and/or facility level. The medical and other authorized personnel access parameters also establish the authorization level assigned to each individual. The assigned authorization level determines the individual's access rights to personal records i.e. read only access, read/write access, read/write/change access etc.

Each registered individual carries a “Smart” data-enabled wireless device 32 that is equipped with registration software. The registration software ensures that the wireless device 32 presents clear identification that the user is registered with the record management system 22. In this particular example, the wireless device 32 presents an identifying logo on its display screen when the wireless device is initialized and on screensavers displayed by the wireless device 32 during periods of inactivity. If the wireless device 32 is being used, the registration software periodically flashes the logo on its display screen. When the logo is displayed, it can be selected resulting in an application being launched that enables the individual to establish a communications link with the record management system 22 via the wireless network 34. In this manner, the wireless device 32 provides clear notice that the individual carrying the wireless device is registered with the record management system 22 and that the individual's medical history is available via the record management system.

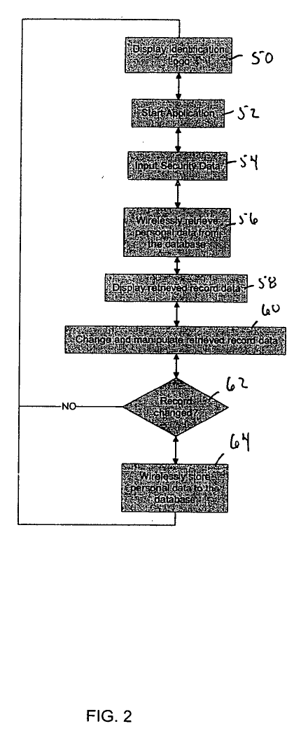

As will be appreciated, carrying a wireless device 32 as described above is particularly advantageous in emergency situations where an individual carrying such a wireless device is in distress and incapacitated. FIG. 2 is a flowchart showing the process steps that are carried out when such an event occurs. In such an event, medical personnel will be able to readily detect that the individual is registered with the record management system 22 by virtue of the fact that the wireless device 32 carried by the individual clearly and regularly displays the identifying logo when operational and when initialized (step 50).

Medical personnel in this case can then select the displayed logo to launch the application and establish a communications link with the database sever 24 of the record management system 22 over the wireless communications network 34 via the gateway server 28 (step 52). When the communications link is established, the medical personnel is presented with a login screen allowing the medical personnel to input their access code (step 54). Once input, the wireless device 32 conveys the access code to the database server 24. With the access code received and confirmed, the database server 24 uses wireless device identification information to retrieve the personal record of the individual (step 56) and transmits the retrieved personal record back to the wireless device 32 for presentation on its display screen (step 58). Alternatively, the personal record of the individual can be accessed by entering and transmitting other personal information concerning the individual to the database server 24. In this manner, the medical personnel is able to review the individual's medical history and take the appropriate action. The medical personnel, if their access rights permit, may also change information and/or add information to the medical history based on the current event (step 60). If changes and/or additions are made, the wireless device 32 transmits this information to the database server 24 (step 62) allowing the individual's personal record stored in the database 26 to be updated (step 64). As a result, the information in the personal record of the individual remains up-to-date.

Alternatively, medical personnel can establish a communications link with the database server 24 of the record management system 22 using a personal computer 36. In this case, the communications link is carried out over the information network 38 via the ASP server 30 using a web browser or the like. When the communications link is established, the medical personnel is presented with a login screen allowing the medical personnel to input their access code. With the access code entered, transmitted to the database server 24 and confirmed, the medical personnel can enter identification information relating to the individual so that the database server 24 can retrieve the personal record of the individual. Once the personal record of the individual is retrieved, the retrieved personal record is transmitted to the personal computer 36 for display. In this manner, the medical personnel is able to review the individual's medical history and take the appropriate action. The medical personnel, if their access rights permit, may also change information and/or add information to the medical history based on the current event. If changes and/or additions are made, the personal computer 36 transmits this information to the database server 24 allowing the individual's personal record stored in the database 26 to be updated. As a result, the information in the personal record of the individual remains up-to-date.

As will be appreciated, accessing the record management system 22 using the wireless device is preferred in situations where access to a personal computer is not readily available or where personal information concerning the individual is not available. Scenes of accidents, during transport or travel etc. are examples of situations of this nature.

The record management system 22 may store the personal records in a single database or in a distributed fashion. Depending on the size of the record management system 22 multiple database servers 24, access gateways 28, ASP servers 30 may be used to accommodate communications traffic and data volume.

If desired, individuals can permit other authorized individuals to have access to their personal records. Also additional non-medical information may be stored in the personal records.

The wireless device need not display a logo which is selectable to launch the access application. The access application in this case is launched by selecting a separate icon presented on the display screen of the wireless device. In addition to presenting the logo, the registration software may also cause the wireless device to output audio information that provides a clear indication that the individual is registered with the record management system. Of course, the audio indication can be used instead of the visual identification.

If desired, in addition to or instead of a PIN type access code, different authentication information can be required to gain access to the record management system. This information may include for example retina scans, fingerprints, DNA etc.

Although an embodiment has been described, those of skill in the art will appreciate that the variations and modifications may be made without departing from the spirit and scope thereof as defined by the appended claims.

What is claimed is:

1. A communications system comprising:
a record management system storing personal records relating to individuals registered with said record management system; and
a wireless device carried by at least one of said registered individuals, said wireless device providing an identifier signifying that the individual is registered with said record management system.

2. A communications system according to claim 1 wherein a plurality of registered individuals each carry a wireless device providing said identifier.

3. A communications system according to claim 2 wherein said record management system and each said wireless device communicate over a wireless communications link to enable data exchange therebetween.

4. A communications system according to claim 3 wherein when a communications link is established between a wireless device and the record management system, the personal record relating to the individual carrying said wireless device is accessible via the wireless device.

5. A communications system according to claim 4 wherein information in an accessed personal record can be changed using said wireless device, changes to information in said personal record being transmitted to said record management system and recorded thereby to update the accessed personal record stored by said record management system.

6. A communications system according to claim 3 wherein said identifier is a logo displayed by said wireless device at least upon initialization of said wireless device.

7. A communications system according to claim 6 wherein said logo is displayed during operation of said wireless device.

8. A communications system according to claim 7 wherein said logo is displayed periodically during operation of said wireless device.

9. A communications system according to claim 6 wherein said logo is selectable, selection of said logo initiating a communications link between said wireless device and said record management system.

10. A communications system according to claim 10 wherein each personal record includes at least medical information concerning the individual.

11. A communications system according to claim 1 wherein each personal record includes at least medical information concerning the individual.

12. A communications system according to claim 11 wherein each personal record is access protected to inhibit unauthorized individuals from accessing personal records.

13. A communications system according to claim 12 wherein access to personal records requires entry of at least one of a PIN, fingerprint, retina scan and DNA sample.

14. A method of accessing a personal record of an individual over a remote communications link comprising:
providing an identifier on a wireless device carried by said individual signifying registration of said individual with a record management system;
establishing a communications link with said record management system;
submitting access data to said record management system signifying authorization to access the personal record of the individual; and
accessing said personal record upon acceptance of said access data.

15. The method of claim 14 wherein said identifier is displayed by said wireless device and wherein said establishing is performed upon selection of said identifier.

16. The method of claim 14 wherein said access data is at least one of a PIN, fingerprint, retina scan and DNA sample.

17. The method of claim 15 wherein said identifier is a record management system logo.
